(19) United States
(12) Patent Application Publication
(10) Pub. No.: US 2005/0229758 A1
(43) Pub. Date: Oct. 20, 2005

(54) Air cut knife

(76) Inventors: Robert Pinto, Chicago, IL (US); Edward D. Kirk, Mundelein, IL (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/055,151

(22) Filed: Feb. 10, 2005

Related U.S. Application Data
(60) Provisional application No. 60/563,683, filed on Apr. 20, 2004.

(51) Int. Cl. B65B 51/04; B26F 3/00

(52) U.S. Cl. 83/177

(57) ABSTRACT

An apparatus and method of severing netting is disclosed. Pressurized air is heated to a temperature sufficient to sever netting. The hot, pressurized air is directed through a nozzle at a neck of gathered netting to sever the netting. A controller controls a motor to move the nozzle through an arc to direct the hot, pressurized air at the neck, and controls a valve to release the hot, pressurized air at the proper time. The nozzle can direct a jet of hot, pressurized air at the netting or can form a chamber having an aperture, wherein the hot, pressurized air contacts the neck of gathered netting in the aperture.

### PRIORITY

This application claims the benefit of U.S. Provisional Patent Application No. 60/563,683, Air Cut Knife, filed on 20 Apr. 2004.

### BACKGROUND OF THE INVENTION

This invention is generally directed to devices that package material in plastic netting or textile netting and to severing that netting between packages. The invention is more particularly directed to cutting netting between two clips.

The food industry often wishes to place products in netting. For example, large fowl, such as turkeys, are encased in a plastic, see-through wrapper, for sanitary reasons, and then enclosed in netting for package integrity and ease of handling. The netting provides a strong structure to hold the turkey and allows the consumer to see the packaged material. Hams and other whole-muscle meat products are often packaged in the same manner.

For example, U.S. Published Patent Application 2004/0168405 discloses an apparatus comprising a product tube, a first clipper, a handle-maker, and a second clipper. The apparatus places the material to be enclosed in a continuous cylinder of netting, previously clipped on one end. The apparatus pulls the material through two irises, pulling the netting about the material. The two irises then close, gathering the netting. One iris moves away, tightening the netting about the material. The handle maker grasps the gathered netting, pulling it tightly around the material, and further makes a loop. The first clipper clips the netting and also severs it. The second clipper clips the loop adjacent the material, to enclose the material in a tight net with a looped handle. The second clipper also clips a label to the loop, for product information. This apparatus, accordingly, requires severing the netting.

Another use for netting in the food industry to pump food products, such as sausage meat, whole muscle meats, or otherwise, through a filling tube or product horn. The food products are forced into an edible film and then into netting. As soon as the edible film has been filled to an extent sufficient for a sausage, a closing machine crimps the sausage casing by engaging the sausage casing from two opposed sides, by closing two crimping shears. After closing, the two crimping shears are moved away from each other in the longitudinal direction of the filling tube, creating, between the two crimping shears, a neck, surrounded by netting, that is free from filling.

Other means of creating a gathered neck of netting have been used besides the irises and crimping shears described above. In manual operations, for example, the netting is gathered by hand to create a neck.

A prior art approach is illustrated in FIG. 1, in which netting 20 encloses two sausages 22, 24. The completed sausage 22 is sealed at its proximal end 26 by clip 28. The filling sausage 24 is sealed at its distal end 30 by clip 32, creating neck 34 between the two clips 22, 24. Knife 36 moves in the direction of arrow 38 to sever netting 20 at neck 34 and to separate the two sausages 22, 24. (Please note that knife 36 can be and often is integral to a clipper that applies one or both clips 22, 24.) The cycle of filling and closing then starts for the next sausage. An exemplary process of this nature is described in U.S. Pat. No. 4,910,034 to Winkler, Process for the Production of Meat Products.

For sausage products, after processing, such as cooking or smoking, the netting 20 will usually be removed before sale to the ultimate consumer, leaving a dimpled appearance on the food products that is considered pleasing to consumers. For products such as hams or turkeys, however, the netting 20 is not removed until final use by the consumer. (The netting process is not limited to meat or even to food products. It can be used for cheeses or for vegetarian sausages, for packaging of small items such as marbles or candy, or for anything else that can be packaged in netting.)

The netting 20 used for these processes is generally a continuous extruded net of flexible plastic material, most commonly polyethylene or polypropylene. Other plastics are sometimes used. Additionally, the netting is sometimes knitted from plastic strands rather than being continuously extruded. Netting can also be made of textile or other fibers. Some netting 20 has elastic elements formed in one dimension and non-elastic elements formed in another dimension, to increase the stretching ability of the netting 20. The netting 20 is manufactured in an elongated, cylindrical form and either rolled onto a tube or packed loosely in a box.

The netting 20 is pulled over the product by various methods known in the art. Regardless of what method is used to encase the product in netting, the elongated cylindrical tube must be severed at some point in the process. When netting 20 is severed with a knife, whether it be formed of plastic, textile, or other fibers, the two severed ends tend to fray and to form small remnant pieces. Fraying causes several problems. For products that are sold netted, such as turkeys and hams, the frayed ends of the netting are unattractive to consumers, who perceive the lack of neatness negatively. Furthermore, in any use of netting involving food, the cleanliness of the packaging room is paramount. It is quite important to keep bits and pieces of the frayed netting out of the packaged food materials.

One solution is to use cut-to-length pieces of netting. The continuous roll stock of netting is cut in a separate room to the desired lengths and transported to the packaging room. This method adds quite a bit of time and expense to the manufacturing process. Additionally, this method is not applicable to continuous processes such as the one described in the U.S. Published Patent Application 2004/0168405 discussed above.

Fraying can be minimized by minimizing the distance between the two clips 28, 32. Sufficient room must be left between the two clips 28,32 for engagement by the knife 36, however, as well as for processing tolerances, so fraying cannot be completely eliminated by this method. Furthermore, the distance between clips 28, 32 cannot always be minimized, such as when adding a handle to the product, as described in the '405 reference discussed above.

Accordingly, a need exists for an apparatus that will sever netting as part of a continuous process and will reduce or eliminate the amount of fraying at the severed end of the netting, regardless of the material used to form the netting. The present invention meets this need.

### OBJECTS AND SUMMARY OF THE INVENTION

A general object of the present invention is to provide a new and improved apparatus and method to sever plastic netting.

Another object of the present invention is to provide a new and approved apparatus for severing netting used in clipping machines engaged in the packaging of materials in plastic netting.

Briefly, and in accordance with the foregoing, the present invention discloses a new and improved system for severing plastic netting by providing a supply of air under pressure, heating that air to a temperature sufficient to sever netting, and directing a jet of hot air at a neck of gathered netting. Plastic netting will melt, to sever without fraying. Textile netting will burn, to sever without fraying.

In one embodiment, the apparatus moves the nozzle directing the jet of hot air through an arc in a plane generally perpendicular to the neck of the netting, to supply the jet of hot air to the proper location when severing of the netting is desired. In another embodiment, the nozzle remains stationary and a controller controls the release of hot air through the nozzle, to supply the jet of hot air when severing of the netting is desired. Alternatively, these two embodiments can be combined, so that the controller releases a jet of hot air only when the nozzle is directed at the neck of gathered netting. In either embodiment, fraying of the severed ends of the netting is eliminated or reduced.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a view of a prior art approach.

FIG. 2 is a diagram view of the preferred embodiment of the system of the present invention.

FIG. 3 is a cross-sectional view of a nozzle of the preferred embodiment of the system of the present invention.

FIG. 4 is a perspective view of a nozzle of the preferred embodiment of the system of the present invention.

FIG. 5 is a perspective view of a nozzle of another embodiment of the system of the present invention.

FIG. 6A is a perspective view of a nozzle of another embodiment of the present invention.

FIG. 6B is a top view of the nozzle of FIG. 6A.

FIG. 6C is a side view of the nozzle of FIG. 6A

FIG. 6D is an exploded view of the nozzle of FIG. 6A.

FIG. 7 is a perspective view of an exemplary netting system using the system of the present invention.

### DETAILED DESCRIPTION OF THE ILLUSTRATED EMBODIMENT

While the invention may be susceptible to embodiments in different forms, there is shown in the drawings, and herein will be described in detail, specific embodiments with the understanding that the present disclosure is to be considered an exemplification of the principles of the invention, and is not intended to limit the invention to that as illustrated and described herein.

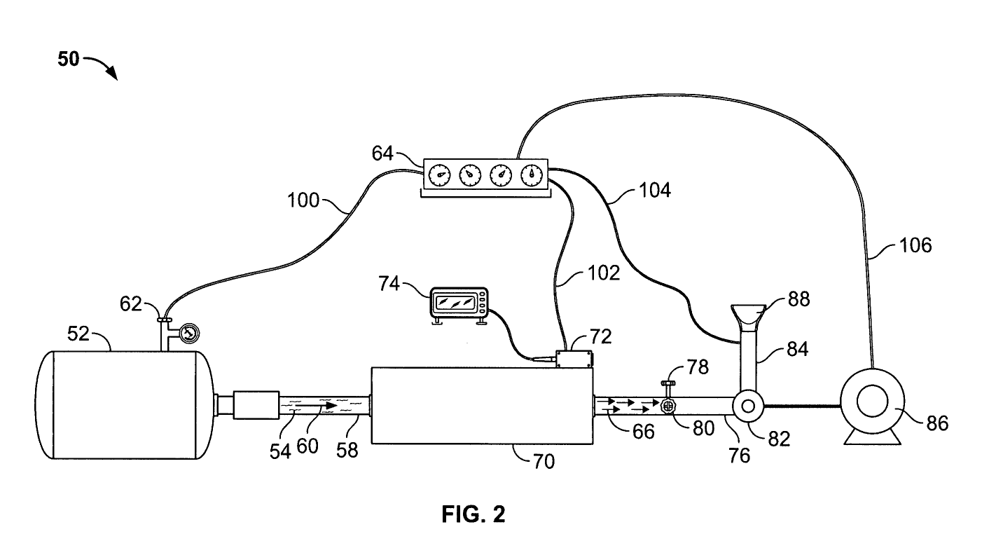

FIG. 2 illustrates in diagram form the air knife system 50 of the preferred embodiment of the present invention. An air supply 52 creates a flow of air 54 under pressure. Air supply 52 can be a compressor, compressed air cylinder, regenerative blower, or any other device for creating pressurized air. Standard atmospheric air is preferable, but other available gases may be used. It is preferable that the pressurized air 54 be clean and dry, especially if the apparatus is to be used in a food processing establishment. It is important that the pressurized air 54 be free of combustible or reactive components.

Please note that high-pressure compressed plant air commonly used in many factories is likely to contain lubricating oil. In this situation, it is preferable that a filter be used to remove any such element.

The pressurized air 54 flows through a cold-air inlet tube 58 in the direction of arrow 60, and is regulated by a pressure regulator 62. Pressure regulator 62 is itself controlled by controller 64. Pressure regulator 62 can, however, be manually controlled.

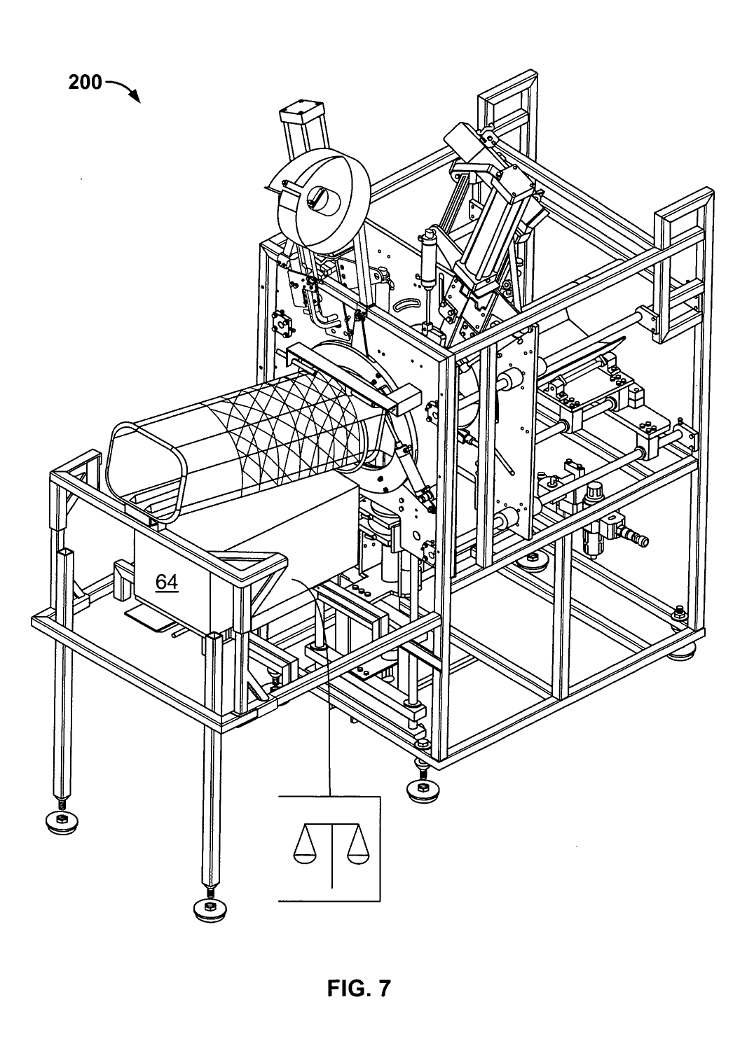

Controller 64 is preferably the same controller as used in the netting system 200 in which the air knife system of the present invention is deployed. An exemplary netting system 200 is shown in FIG. 7 and is preferably the type described in copending U.S. patent application Ser. No. 10/787,988. In the preferred embodiment, controller 64 is a standard Siemens central processing unit, with a “power 56EP1333-1SL11” power supply, a “Simatic S7-300 314-1AEO4-0AB0” PLC, a 32-output “SM322 321-1BL00-0AA0” card, a 32-input “SM 321 321-ABL00-0AA0” card, and a 16-input “SM 321 321-1 BH0S-0AA0” card. Any microprocessor-based controller will suffice, as will an analog controller. Alternatively, the entire operation can be controlled manually.

The pressurized air 54 enters an air heater 70. Heater 70 is preferably an electric in-line heater, such as those heaters, part numbers 038821 through 038826, manufactured by Osram Sylvania, Exeter, N.H. A different type of heater can be used, however, such as a steam heater, gas heater, oil heater, infrared heater, solar heater, heat exchanger, or any other apparatus to heat the pressurized air 54 to a temperature sufficient to sever netting 20.

In the preferred embodiment, heater 70 has at least one thermocouple 72 to measure the temperature of the exiting, heated pressurized air 66. Thermocouple 72 is coupled to controller 64 for automatic control. However, thermocouple 72 could be attached to a visible temperature display 74 in a manual system.

Hot pressurized air 66 exiting heater 70 through hot-air outlet tube 76 is regulated by second pressure regulator 78, which is coupled to regulator valve 80. In the preferred embodiment, second pressure regulator 78 is controlled by controller 64.

Outlet tube 76 connects via rotating connector 82 to delivery tube 84. Rotating connector 82 is actuated by motor 86, which rotates connector 82 to move delivery tube 84 through an arc of approximately ninety degrees. Motor 86 is controlled, in the preferred embodiment, by controller 64. In a manual embodiment, delivery tube 84 can be swung through an arc by hand. Alternatively, delivery tube 84 can be moved by an air-actuated cylinder, a hydraulic piston, a solenoid, a bell crank, or other means of providing motion.

Please note that heater 70, outlet tube 76, connector 82, and delivery tube 84 are all hot during operation. Accordingly, care should be taken to insulate these elements or to isolate them from contact with humans or flammable materials.

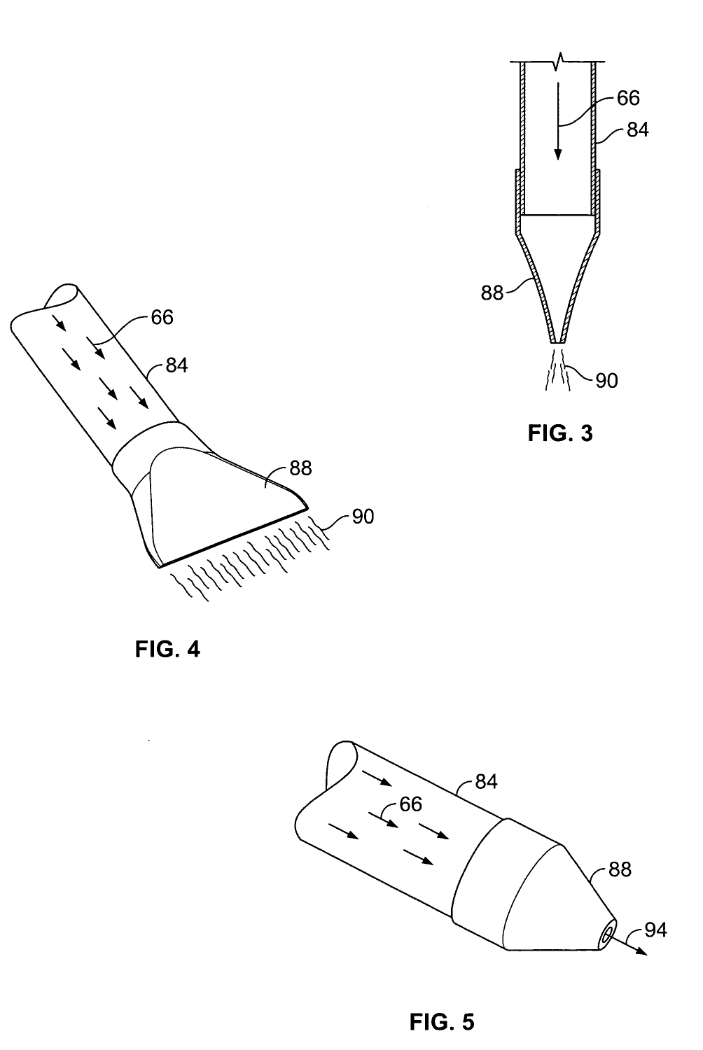

Delivery tube 84 terminates at nozzle 88. In the preferred embodiment, nozzle 88, as illustrated in FIGS. 3 and 4, is configured to project a generally planar jet 90 of hot pressurized air 66. Accordingly, the nozzle 88 can be, for example, configured as shown in the Osram Sylvania “Process Heaters” catalog at page 9 and at http://www.sylvania.com/pmc/heaters/air/hatools.htm. Other nozzle designs that project a generally planar jet 90 of hot pressurized air 66 will suffice. Alternatively, delivery tube 84 can simply be flattened at its distal end to simulate the shape of nozzle 88.

In another embodiment, nozzle 88 can be configured to project a linear jet 94 of hot pressurized air 66, as shown in FIG. 5.

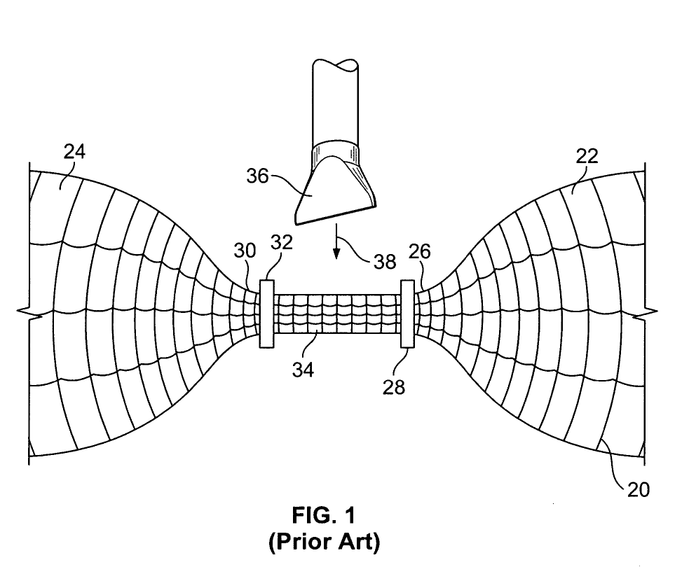

In operation, hot air knife system 50 is used to replace the knife 36 in any clipping situation where frayed ends of netting 20 are not desired. For example, in the sausage-making process described above and illustrated in FIG. 1, the hot air knife system 50 of the present invention is used to sever the netting 20 at neck 34 between the two clips 28, 32. Instead of a knife 36 chopping through the neck 34, a jet 90 of hot, pressurized air 66 cuts the netting 20 (and, if sausage, the edible film). The jet 90 is hot enough to melt the plastic of the netting 20, causing it to sever. The jet 90, however, since it is swinging through an arc, only heats the netting 20 momentarily. As soon as the jet 90 has moved away from the neck 34, the severed, melted ends of the netting 20 harden. By hardening, the netting 20 does not fray.

Controller 64 is preferably a microprocessor-based controller and is preferably the same as or integrated with the controller for the automated netting system 200 to which the air knife system 2 of the present invention integrates. Controller 64 has the following control loops, as illustrated in FIG. 2:
a. Controller 64 monitors and controls pressure of the flow of air 54 from air supply 52 through feedback loop 100, which couples controller 64 to first pressure regulator 62, which regulates air supply 52;
b. Controller 64 monitors and controls temperature of the hot, pressurized air exiting heater 70 through feedback loop 102, which couples controller 64 to heater 70 and thermocouple 22;
c. Controller 64 monitors and controls pressure of hot, pressurized air 66 exiting heater 70 through feedback loop 104, which couples controller 64 to second pressure regulator 78, which controls valve 80);
d. Controller 64 controls motor 86 by feedback loop 106, and therefore controls the movement of delivery tube 84.

Accordingly, a variety of control schemes will be apparent to the practitioner. In the preferred embodiment, controller 64, having sensed that the automated netter 200 is at the point in its operation that the netting 20 should be severed, signals motor 86 to move delivery tube 84 through a arc of ninety degrees, whereby the jet 90 emanating from nozzle 88 moves across the netting 20 at neck 34, severing neck 34 and preventing fraying. In the preferred embodiment, controller 64 only opens valve 80 during that portion of the arc in which jet 90 is crossing the neck 34. In another embodiment, however, valve 80 is always open so that jet 90 is always emitting from nozzle 88.

In other embodiment, delivery tube 84 does not rotate through an arc, except perhaps for maintenance. In this embodiment, nozzle 88 is always pointed at the appropriate location within the automated netter apparatus 200. When the time comes in the automated netting process to sever the netting 20 at neck 34, controller 64 opens valve 80, releasing hot pressurized air 66 to sever the netting 20.

Various control algorithms can be devised by a user to achieve the goals of the present invention.

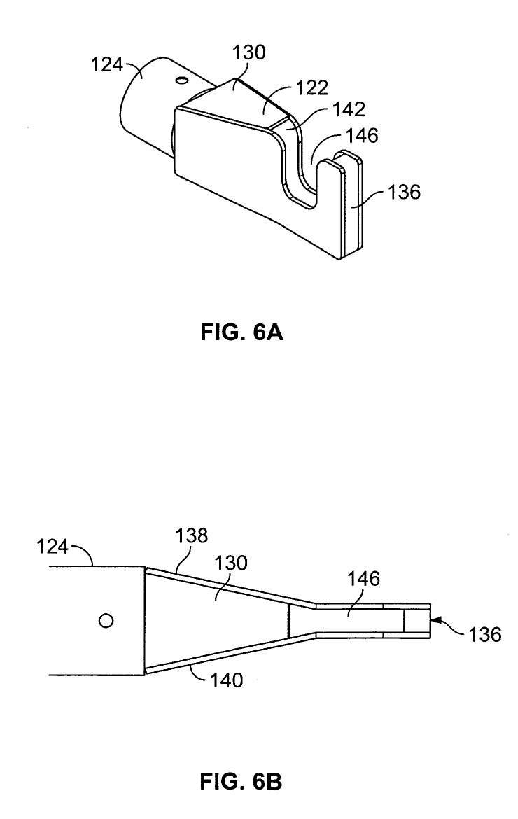

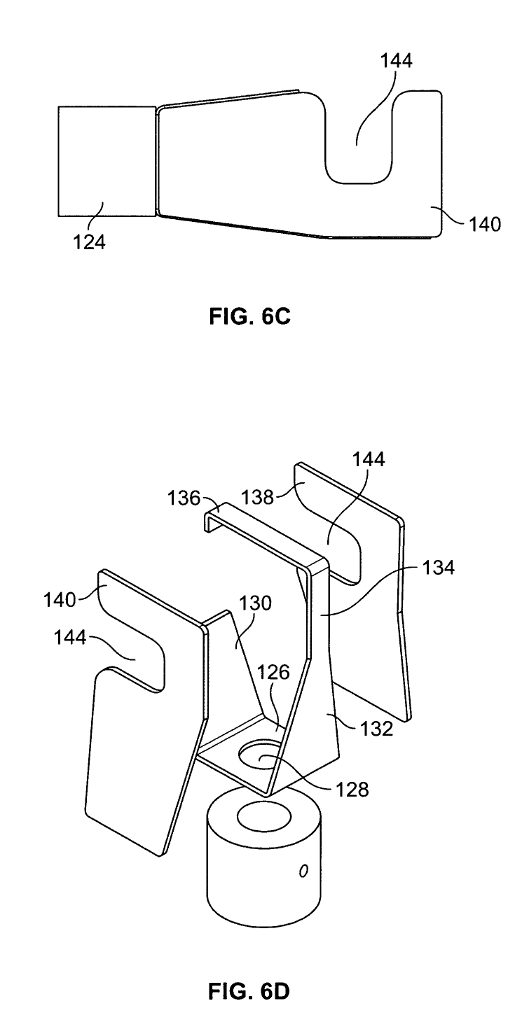

Another embodiment of the nozzle of the present invention is shown in FIGS. 6A through 6D. In this embodiment, delivery tube 84 attaches to nozzle 122 at attachment 124. Nozzle 122 is formed of a base plate 126 having aperture 128. Top plate 130 and bottom plate 132 project from base plate 126. A cowl 134 projects from bottom plate 132 to form aback shield 136 opposing base plate 126. Two side shields 138,140 enclose base plate 126, top plate 130, and bottom plate 132, to form chamber 142. Notches 144 in side shields 138, 140 form an aperture 146.

Accordingly, hot air 66 flows through delivery tube 84 and aperture 128 into chamber 142. A neck 34 of netting 20 presented in aperture 146 will then be contacted by hot air 66, severing that netting 20. Because of cowling 134 and back shield 136, the hot air 66 is confined somewhat within aperture 146, thereby increasing the force of the hot air 66 and providing for more efficient severing of the netting 20, as hot air 66 that bounces off cowling back shield 136 will be redirected back at the other side of netting 20.

Please note that use of this type of nozzle requires more precise control of delivery tube 84. In this embodiment, delivery tube 84 is swung through an arc so that the neck 34 of netting 20 is placed precisely in aperture 146.

While a preferred embodiment of the present invention is shown and described, it is envisioned that those skilled in the art may devise various modifications of the present invention without departing from the spirit and scope of the appended claims.

1. An apparatus for severing netting comprising:
an air supply to create a flow of pressurized air;
a heater to heat said pressurized air;
a nozzle coupled to said heater to direct said heated pressurized air to a neck of gathered tubular netting.

2. The apparatus of claim 1, further comprising means for moving said nozzle through an arc.

3. The apparatus of claim 2, further comprising a controller to control said means for moving.

4. The apparatus of claim 2, further comprising a valve to regulate said heated pressurized air.

5. The apparatus of claim 4, further comprising a controller to control said means for moving and said valve.

6. The apparatus of claim 1, further comprising a valve to regulate said heated pressurized air.

7. The apparatus of claim 6, further comprising a controller to control said valve.

8. The apparatus of claim 1, wherein said nozzle further comprises a back shield to redirect said heated pressurized air at said neck.

9. The apparatus of claim 1, wherein said nozzle is configured to produce a planar jet of heated pressurized air.

10. An apparatus comprising:
an air supply to create a flow of pressurized air;
a heater to heat said pressurized air;
means for gathering a tubular netting into a neck; and
a nozzle coupled to said heater to direct said heated pressurized air to said neck.

11. The apparatus of claim 10, further comprising means for moving said nozzle through an arc.

12. The apparatus of claim 11, further comprising a controller to control said means for moving.

13. The apparatus of claim 11, further comprising a valve to regulate said heated pressurized air.

14. The apparatus of claim 13, further comprising a controller to control said means for moving and said valve.

15. The apparatus of claim 10, further comprising a valve to regulate said heated pressurized air.

16. The apparatus of claim 15, further comprising a controller to control said means for moving and said valve.

17. The apparatus of claim 10, wherein said nozzle further comprises a back shield to redirect said heated pressurized air at said neck.

18. The apparatus of claim 10, wherein said nozzle is configured to produce a planar jet of heated pressurized air.
